(19) United States
(12) Patent Application Publication
(10) Pub. No.: US 2011/0271275 A1
(43) Pub. Date: Nov. 3, 2011

(54) SOFTWARE DISTRIBUTION MANAGEMENT METHOD OF COMPUTER SYSTEM AND COMPUTER SYSTEM FOR SOFTWARE DISTRIBUTION MANAGEMENT

(75) Inventors: Hiroyuki Ochi, Kawasaki (JP); Mitsunori Satomi, Tokyo (JP); Nobuo Beniyama, Yokohama (JP); Norihiro Kobayashi, Yokohama (JP)

(73) Assignee: HITACHI, LTD., Tokyo (JP)

(21) Appl. No.: 12/864,184

(22) PCT Filed: Apr. 28, 2010
(86) PCT No.: PCT/JP2010/003077

§ 371 Date: Jul. 22, 2010

(51) Int. Cl. G06F 9/445

(52) U.S. Cl. 717/177

(57) ABSTRACT

[The present invention] improves the user-friendliness of a software distribution management system that uses representative clients.

The computer system according to the present invention comprises a plurality of clients, a server computer that includes software to be distributed to one or more of the plurality of the clients, and a network for coupling the server computer to the plurality of client computers. Based on information from the plurality of clients, the server computer classifies the plurality of clients into a plurality of groups, selects a representative client for each group, and executes distribution of the software to the representative clients. The representative clients that have received the software distribution distribute the software to the other clients belonging to the same group. The server computer outputs management display information to a management screen on the basis of software distribution management information. Note that the distribution of software from the server computer to the representative clients may also be performed in advance.

### TECHNICAL FIELD

The present invention relates to a software distribution management method of a computer system and a computer system for software distribution management.

### BACKGROUND

With technology for distributing large-capacity software programs to clients, there are bottlenecks in communications between clients and centralized management servers. This trend is prominent in environments where the centralized management server is connected to a group of clients via a relatively low-speed line such as the Internet.

An example of a countermeasure is the distribution of a P2P software program between a plurality of clients in order to reduce the number of communications between the server and clients and lighten the communication load.

An example of conventional technology related to this type of system is disclosed in U.S. Patent 2009-271904. This conventional technology proposes a P2P-type system for distributing a software program that is designated by a system administrator to a group of clients, i.e. so-called push-type distribution. In other words, the management apparatus selects a representative client from the group of clients, and causes the representative client to operate as a relay server so that the software program is distributed from the representative client to the other clients.

Furthermore, this conventional technology discloses an arrangement whereby a number of representative clients that ensures sufficient parallelism in the software distribution processing is determined in order to satisfy a software program distribution deadline that is designated by the system administrator.

Another related conventional technology is also disclosed in U.S. Patent Publication No. 7529809. This conventional technology discloses a system in which a software program is distributed with the timing required by the client users, i.e. a so-called pull-type software program distribution system which reduces the number of times a software program is transferred between the server and clients.

Specifically, a system is proposed in which, if a plurality of clients request a software program at a remote site, a negotiation takes place between the plurality of clients and the software program is downloaded to the representative client from the remote site only once.

### CITATION LIST

### Patent Literature

[PTL1] Patent Publication No. 2009-271904
[PTL2] U.S. Patent Publication No. 7529809

### SUMMARY OF INVENTION

### Technical Problem

Although existing conventional technologies disclose software distribution using representative clients, there is room for improvement where user-friendliness is concerned. Two such examples are as follows.

(A) The existing conventional technologies exhibit poor user-friendliness from a management perspective in that it is not possible to identify the status of the software distribution to the clients, such as the configuration affecting software downloads, or the progress of software downloads.

(B) With the existing conventional technologies, if the software is not present in a representative client, it takes time for the client to acquire the software from the server via the network, which is inconvenient for the user using the client.

An object of the present invention is therefore to provide either or both of the following two benefits.

(1) A software distribution management system with which it is possible to ascertain the status of software distribution to the clients and the progress of software downloads, and so forth.

(2) A software distribution management system with which the clients are able to rapidly acquire software from the server via the network.

### Solution to Problem

In order to solve such problems, the present invention therefore comprises a plurality of clients, a server that includes software to be distributed to one or more of the clients, and a network for coupling the server to the plurality of clients.

Based on information from the plurality of clients, the server classifies the plurality of clients into a plurality of groups, selects a representative client for each group, and distributes the software to the representative clients.

The representative clients which have received the software distribution distribute the software to the other clients belonging to the same group.

The server outputs management display information to a management screen on the basis of software distribution management information. Note that the distribution of software to the representative clients from the server may also be performed in advance.

### Advantageous Effects of Invention

With the present invention described above, the user-friendliness of a software distribution management system that uses representative clients can be improved.

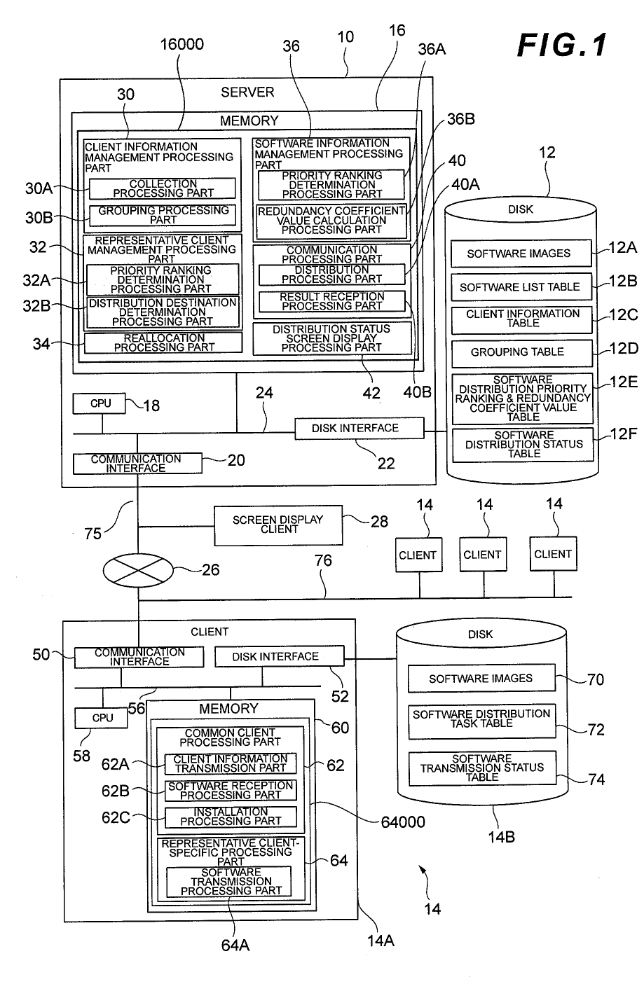

### BRIEF DESCRIPTION OF DRAWINGS

[FIG. 1]

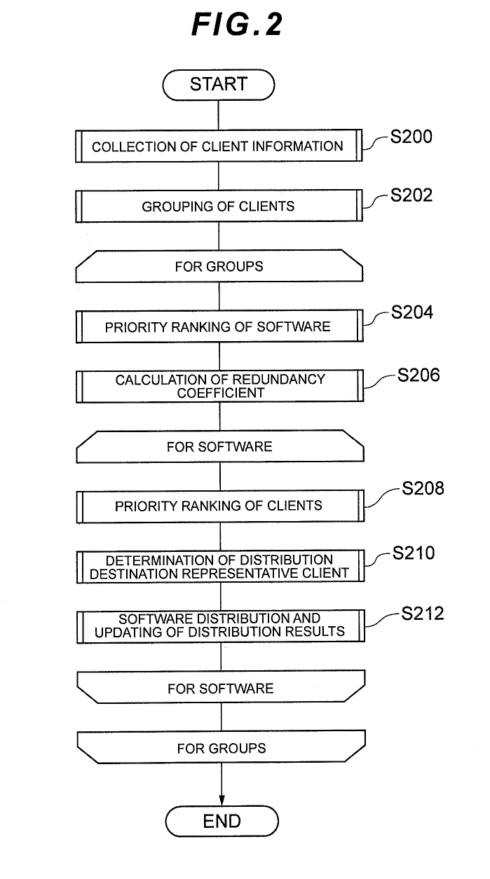

A block diagram of a computer system for distributing software to a client group from a management server, according to an embodiment of the present invention.

[FIG. 2]

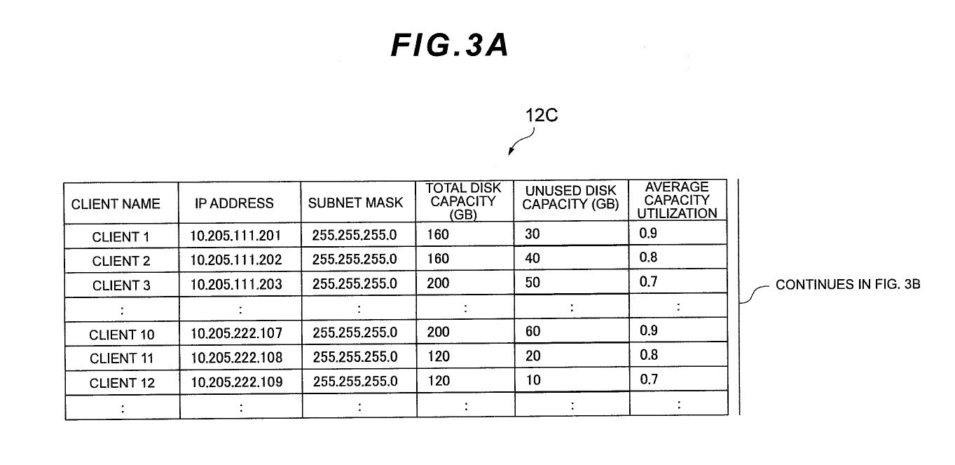

A flowchart for fulfilling the main function of a server.

[FIG. 3A]

Part of a client information table.

[FIG. 3B]

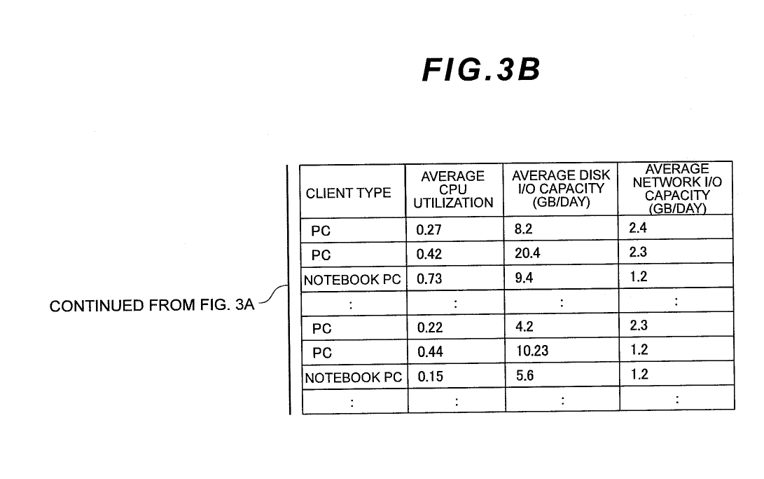

Another part of the client information table.

[FIG. 4]

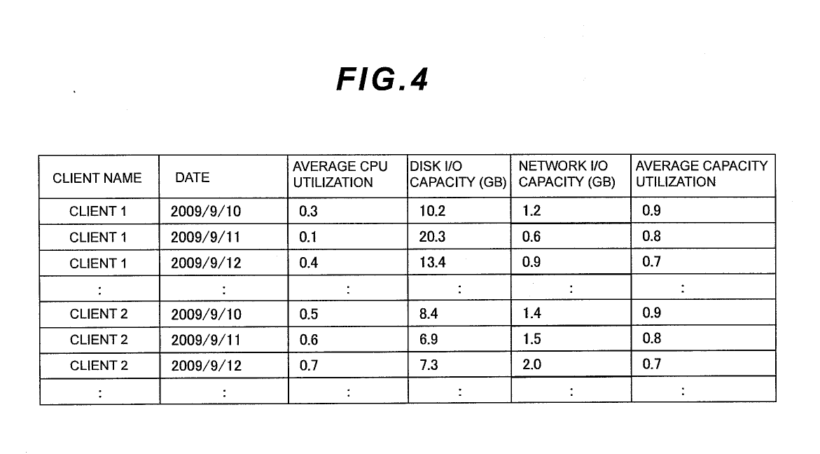

An example of a client information history table.

[FIG. 5]

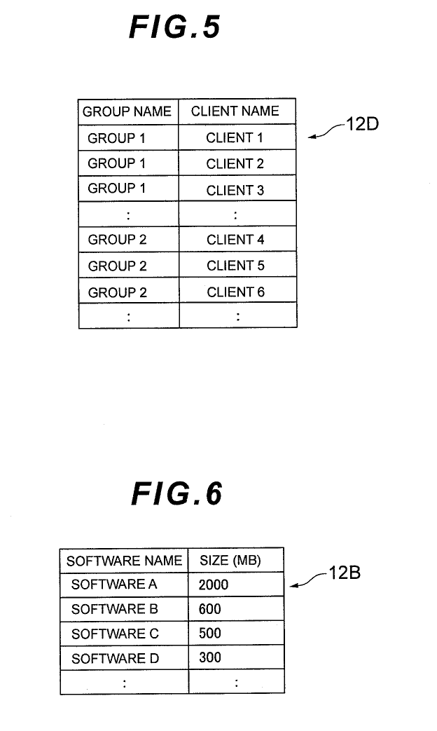

An example of a client grouping table.

[FIG. 6]

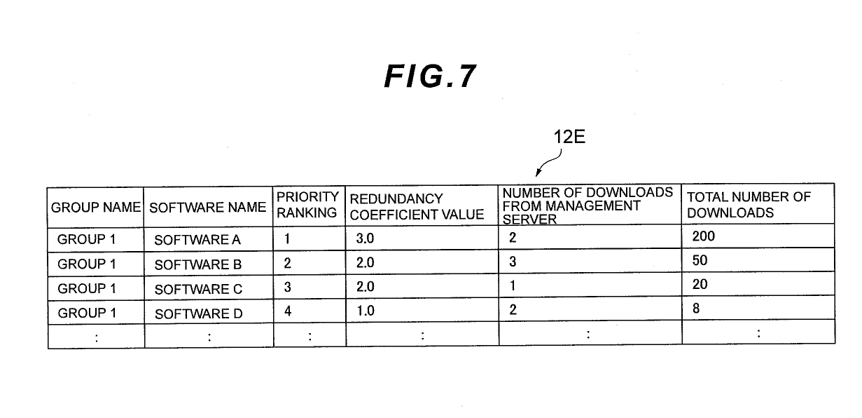

An example of a software list table.

[FIG. 7]

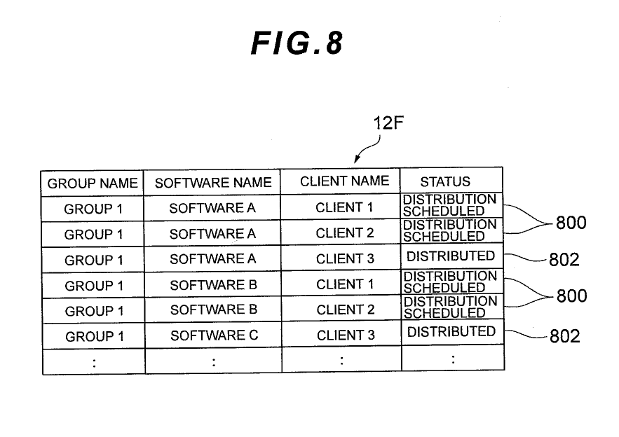

An example of a software distribution priority ranking and redundancy coefficient value table.

[FIG. 8]

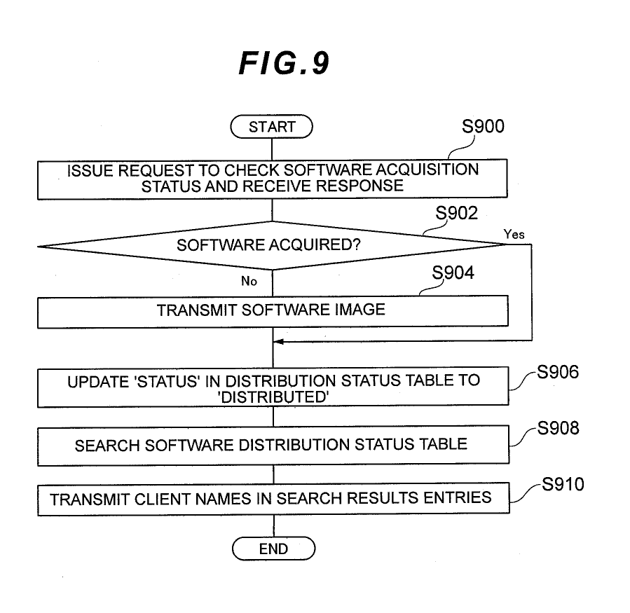

An example of a software distribution status table.

[FIG. 9]

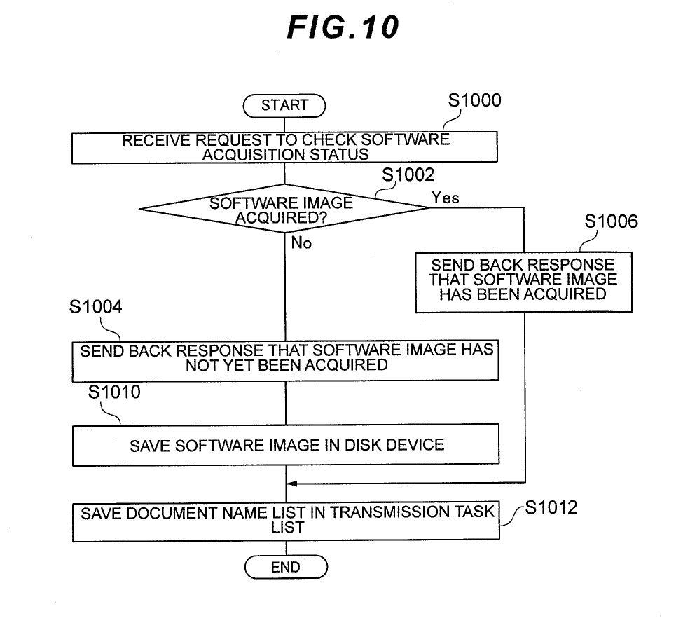

An example of a flowchart which corresponds to processing in which a server transmits software to a representative client.

[FIG. 10]

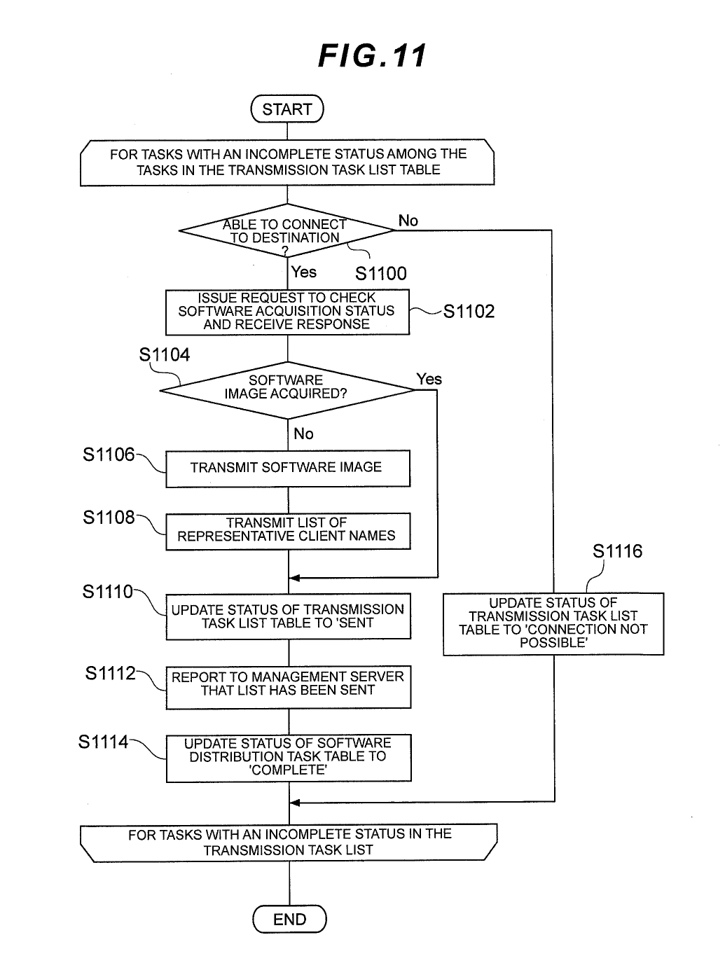

A flowchart for an example of processing in which the representative client receives software from the management server.

[FIG. 11]

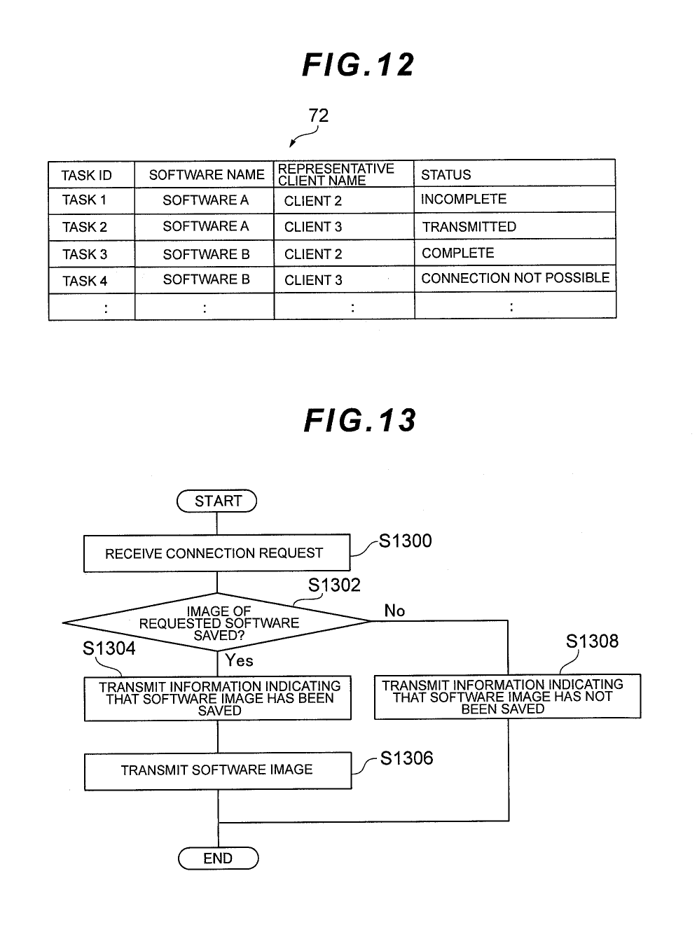

A flowchart for an example in which the representative client transmits software to another representative client in the same group.

[FIG. 12]

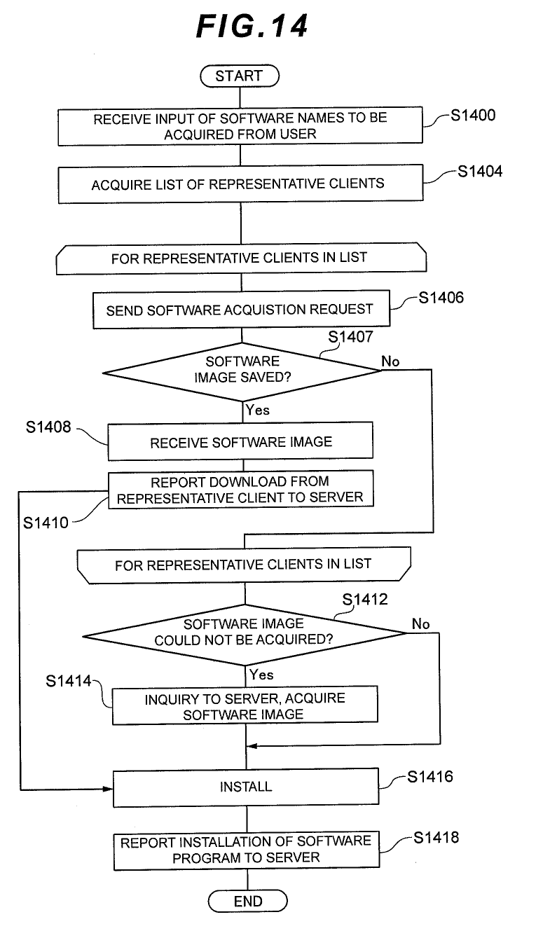

An example of a software distribution task table.

[FIG. 13]

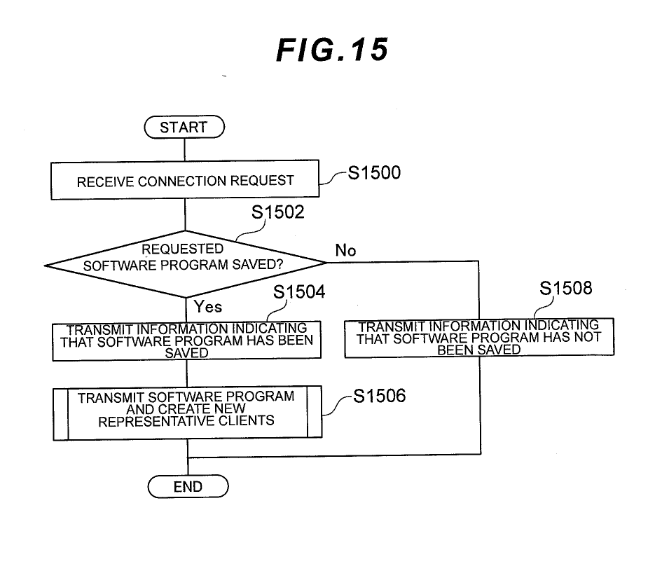

An example of a flowchart of software distribution processing of a representative client.

[FIG. 14]

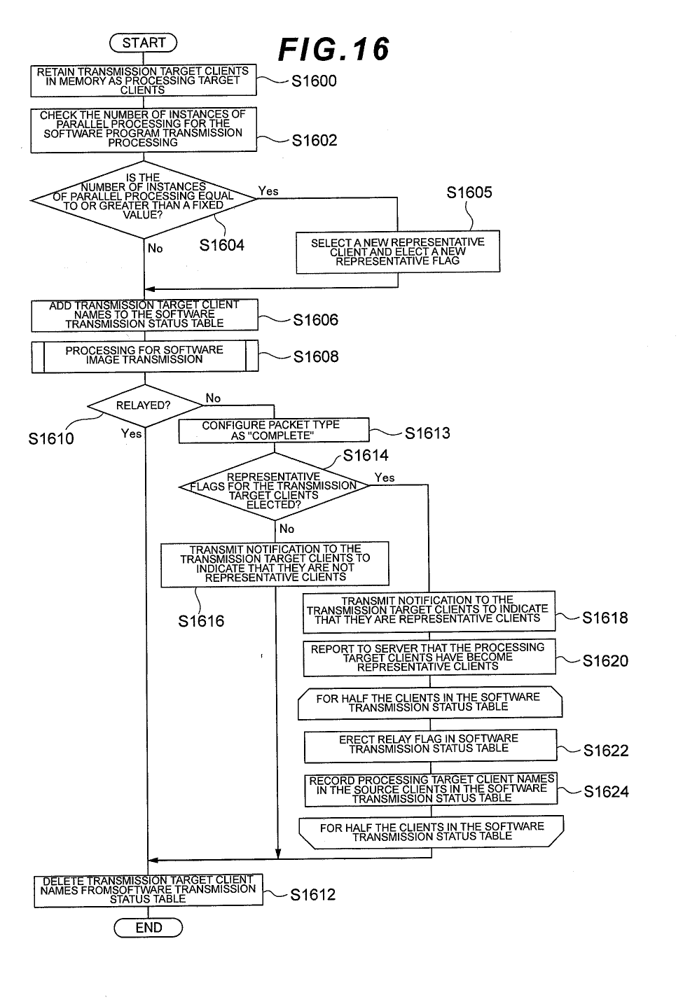

An example of a flowchart of software reception processing by a client requesting software and of installation processing.

[FIG. 15]

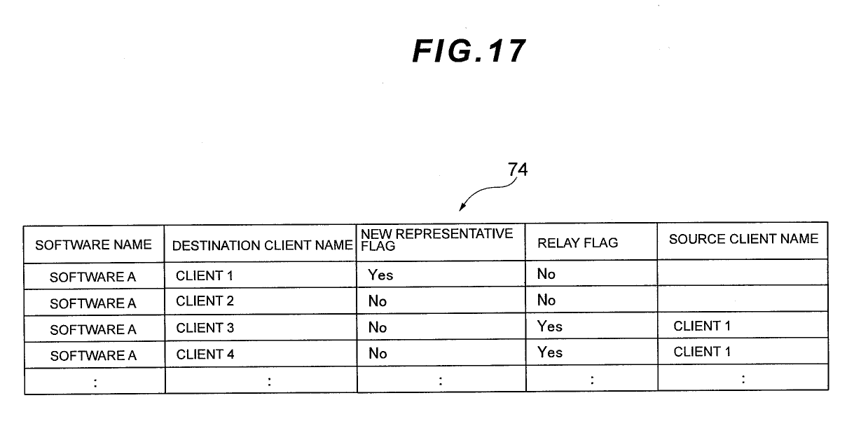

An example of a flowchart providing an overview of representative client operation.

[FIG. 16]

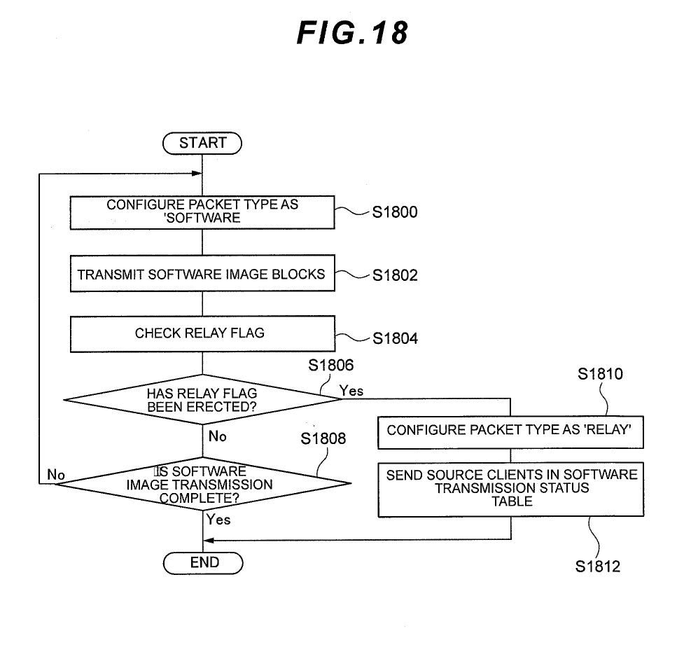

An example of a flowchart of processing for creating a new representative client from a plurality of clients.

[FIG. 17]

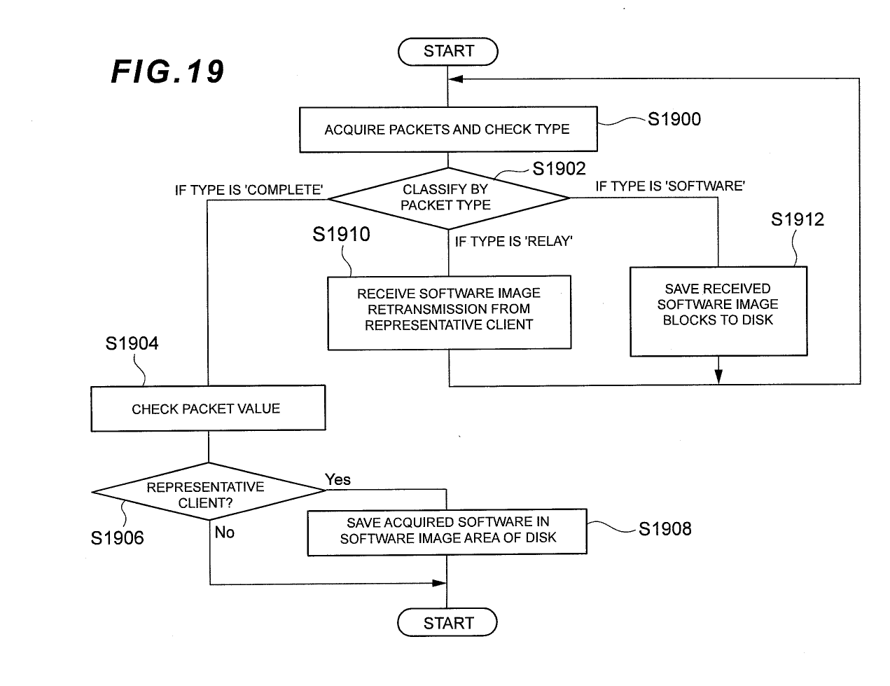

An example of a software transmission status table.

[FIG. 18]

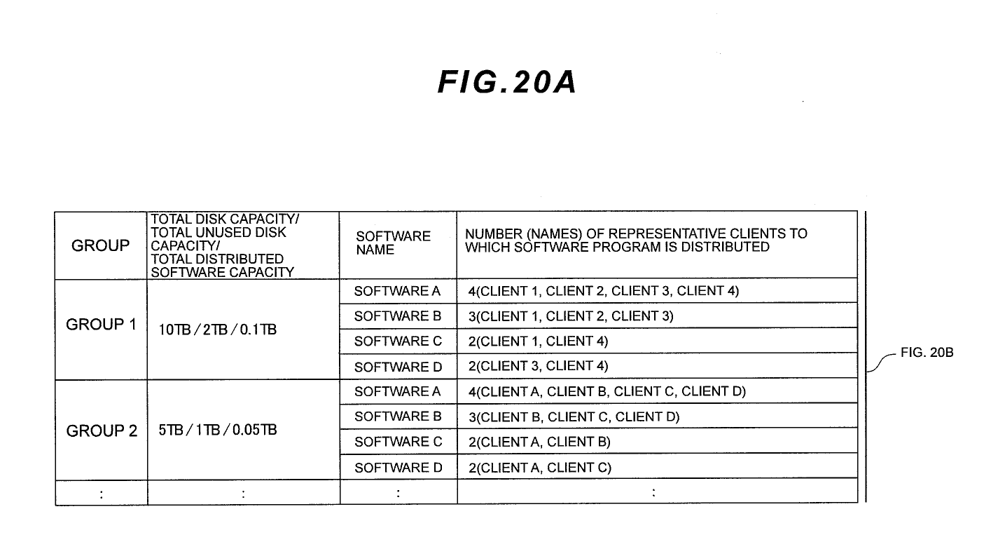

An example of a flowchart in which a representative client transmits or relays software.

[FIG. 19]

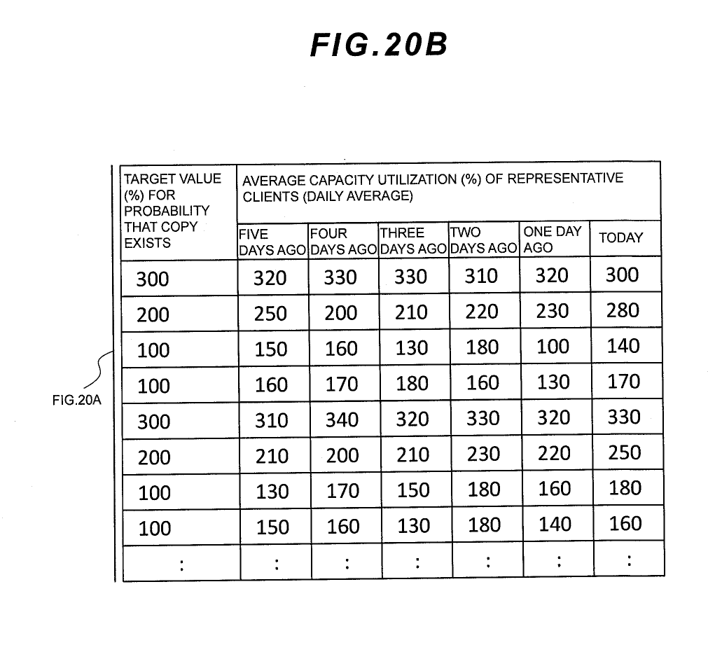

An example of a flowchart in which a client receives software.

[FIG. 20A]

Part of a software distribution management screen.

[FIG. 20B]

Another part of a software distribution management screen.

### DESCRIPTION OF EMBODIMENTS

An embodiment of a computer system according to the present invention will be described hereinbelow. Note that, in the following description, information on the present invention will be described using expressions such as ‘aaa table,’ ‘aaa list,’ ‘aaaDB [database],’ and ‘aaa queue,’ but this does not necessarily mean that this information is restricted to being a table, a list, a DB, or a queue or similar. This information may also be expressed using another kind of data structure.

Hence, in order to show that there is no dependence on data structure, the ‘aaa table,’ ‘aaa list,’ ‘aaaDB,’ and ‘aaa queue’ and so on will sometimes be referred to as ‘aaa information.’

Furthermore, although expressions such as ‘identification information,’ ‘identifier,’ ‘title,’ ‘name,’ and ‘ID’ are used in describing the content of each information item, such expressions are interchangeable.

The subject of the following description may sometimes be ‘program.’ However, since predetermined processing is executed using memory and a communication port (communication controller) as a result of the program being run by the CPU, the subject of the following description may also be the CPU.

Furthermore, processing that is disclosed here with the program as the subject may be processing that is executed by a computer on which the program is run. In addition, some or all programs may be realized by dedicated hardware.

Moreover, various programs may also be installed on each computer by a program distribution server computer or using storage media.

FIG. 1 is a block diagram of a computer system for distributing a software program to a group of client computers from a management server computer.

Note that the hardware configuration of the computer system is similar to that disclosed in the aforementioned Patent Publication 2009-271904. This application therefore claims priority from Japanese Patent Application No. 2009-271904, the entire disclosure of which is incorporated herein by reference.

The computer system has a configuration in which a server computer (hereinafter referred to simply as a ‘server’) 10, which comprises files including software programs and which manages the distribution of software images corresponding to software programs to client computers, and a plurality of client computers (hereinafter referred to simply as ‘clients’) 14 are connected by a wide area network 26 such as the Internet.

Note that ‘software images corresponding to software programs’ includes information enabling clients to execute the software programs which are to be installed and/or programs. This definition applies if ‘corresponding’ is used in the context of a software program and software image. The expression ‘software images corresponding to software programs’ is long when used in describing an embodiment and will therefore sometimes be rendered simply as ‘software images.’ Note that the following serve as the aforementioned ‘information enabling clients to execute [the software] and/or ‘programs.’
Software program files and configuration information. Naturally, a software image may be a software program file.
Installation program files for installing software programs and configuration information for installation programs.

Note that, by executing an installation program, a client may download some or all files (or data) of a software program from the server 10 or another computer.

Furthermore, by executing an installation program, a client may be able to extract and execute a software program from data embedded in installation program files. The software image may also include an identifier for the corresponding source software program.

Note that a software image that corresponds to a predetermined software program stored by a representative client and a software image that corresponds to the predetermined software program stored by a distribution server need not contain identical data. This is because, as long as a predetermined software program that has been designated can be installed, the client issuing the request does not particularly distinguish the data of the software image.

Likewise, note that a software image that corresponds to a predetermined software program stored by a first representative client and a software image that corresponds to the predetermined software program stored by a second representative client need not contain identical data. This is because, as long as a predetermined software program that has been designated can be installed, the client issuing the request does not particularly distinguish the data of the software image.

Given this situation, a software image sent by a representative client to a client (or other representative client) may be identical to the software image that is received by the representative client, or may correspond to an identical software program.

Note that if there is no requirement for installation image data consistency between any two of the aforementioned server, one representative client and another representative client, the priority rankings of software programs may also be adopted in place of priority rankings of software images.

Note that ‘distribution’ as it is referred to in this specification refers to the act of transferring a software image for distribution between computers. Note that the following serve as examples of transfers between computers.
From a server to a client or representative client.
From a representative client to a client or another representative client Hence, ‘distribution’ may be read interchangeably as the act of ‘transmitting,’ ‘receiving,’ or ‘transferring’ by a server, client, or representative client. This may also include or not include the installation of a corresponding software program by using a ‘distributed’ software image distributed by a computer.

Note that ‘install’ refers to processing enabling execution of a software program that is to be installed. The following shall serve as an example of such processing enabling execution.
A software program that is to be installed is initially executed by a client targeted for the installation.
Software program files are stored in a suitable folder (or directory) on a disk of a client suitable for program execution. Although not required, configuration information for the software programs may also be recorded in a configuration file or registry.
In the case of application streaming for application virtualization in which a software program is split and distributed on-demand, ‘install’ may, by way of another example, refer to processing to allow part of the program to be received on-demand while the distributed software program is being run.

The server 10 classifies a plurality of clients into groups and determines the client in each group to which a software image should be distributed. In order to distinguish the clients which receive distribution of a software image from the other clients, the applicable clients will be referred to hereinbelow as ‘representative clients.’ The clients which requests a software image receives distribution of a software image from a representative client of the same group. These clients will be called request-source clients in order to distinguish them from the representative clients.

In pull-type communications, the number of communications with the server, which can lead to a bottleneck, can be effectively reduced by pre-installing a software image in the group to which the clients belong. Furthermore, since there are also a large number of clients cut off from the network such as notebook PCs, a software image is preferably installed redundantly in the client group. Note that to install a software image means to store a software image in a representative client.

That is, the computer system pre-distributes a software image on a server to the representative clients so that pull-type software image distribution can be executed rapidly in an environment where a relay server is omitted, and forms this software image in the representative clients to allow the software image to be transferred to other clients, in other words, forms a temporary copy of the software image in the representative clients, i.e. caches the software image.

Here, in order to provide clients with a software image cache given a limited storage capacity, the computer system has the following main functions installed.

The first main function is for selecting a software image that is distributed to a representative client from the server. If a software image corresponding to an intended software program has not been received by the request-source client from the representative client, the request-source client receives distribution of the intended software image by accessing the server.

Not only does it take a long time to distribute the software image since a low-speed network is then involved, but also the load on the server increases. The server therefore makes a determination from the characteristics of the software program and the download status managed by the server, and prioritizes the distribution of high-priority software images to the clients over other software images to the extent permitted by the unused disk capacity the client.

The second function is for assuming the probability, per unit time, that the request-source client will be able to access the software image corresponding to the intended software program, and redundantly configures the representative client storing the software image in order to satisfy this probability.

The server redundantly introduces a plurality of clients to the computer system to allow the request-source client to access the representative client at the point in time where the request-source client requires distribution of the software program (or software image).

When the system administrator configures, on the server, a characteristic value relating to the redundancy of the representative client, as a target value, the server selects a representative client to satisfy this target value. Note that the server determines a representative client by using information on the client's capacity utilization.

A third function is for performing maintenance on the installation of a software image in one group. Upon receiving [notification of] additional client installations/client removals or changes in the software image priority rankings, the server changes the representative clients or the software images held by the representative clients.

The hardware configuration and various operations of the computer system will be explained in detail hereinbelow. The reference numeral 14A denotes a client for which the hardware configuration is shown in detail. The other clients are also configured in the same way. The reference numeral 12 denotes a disk device which is a storage area of the server 10.

The reference numeral 14B denotes a disk device of the client 14A. The disk device is also connected to the other clients. A plurality of clients 14 are interconnected by a LAN 76. A client 28 for displaying server management information is connected to the server LAN.

The server 10 comprises a memory 16 for storing program code required to implement software image distribution control, a processor 18 for performing control of software distribution on the basis of the program, an interface 22 for controlling communications with a disk device 12, an interface 20 for controlling communications with the client, and a bus 24 for connecting each of the aforementioned elements to one another. The memory 16 stores a software distribution management program 16000, and by executing this program, the CPU 18 performs processing to manage the software distribution by the server 10.

The processing to manage the software distribution by the server 10 is achieved by a plurality of functions. In order to clarify these functions, the memory 16 is illustrated as a function block diagram in which blocks are allocated to each one of a plurality of functions. Stated differently, each of the processing parts (30, 32, 34, 36, 40, and 42) can also be said to be incorporated in the software distribution management program 16000. Furthermore, in other words, descriptions relating to each of the processing parts are also interchangeable with descriptions pertaining to the software distribution management program 16000.

The client information management processing part 30 manages client information, and mainly inventory information. The client information management processing part comprises a processing part 30A for collecting client information from the clients, and a processing part 30B for grouping a plurality of clients on the basis of the client information.

A software information management processing part 36 comprises a priority ranking determination processing part 36A for managing software image information of the server 10, and for determining, for each group of clients, the priority ranking with which the system administrator is to distribute a software image to the clients; and a redundancy coefficient value computing processing part 36B for computing a characteristic value (redundancy coefficient value) pertaining to the redundancy of a copy of a software image (software image cache) in each group of clients.

The representative client management processing part 32 comprises a processing part 32A for managing, for each group of clients, the client (representative client) to which the software image is to be pre-distributed, and for determining the priority ranking of clients, and a processing part 32B for determining the representative client on the basis of the priority ranking.

The communication processing part 40 comprises a distribution processing part 40A for controlling communication with the clients and for performing processing to distribute software images, and a result reception processing part 40B for receiving distribution results from the clients.

A re-installation processing part 34 performs processing to rebuild a software image installation in the client groups, and a distribution status screen display processing part 22 executes processing to display a management screen on a screen display client.

The disk device 12 connected to the server comprises data 12A of a software image that is distributed to the clients from the server 10, a table 12B with a software program list, a client information table 12C, a client-grouping information table 12D, a table 12E containing priority rankings for distributing software images and redundancy coefficient values, and a software image distribution status table 12F.

The client 14A comprises a communication interface 50 for controlling communications with the server, a disk interface 52 for controlling communications with the disk device 14B, a processor 58 for controlling processing to receive the distribution of software images from the server 10 or a representative client and processing in which the representative client distributes a software image to the client which issued the software image request, a memory 60 in which a program for the aforementioned processing is stored, and an internal bus 56 for connecting each of these elements to one another. The memory 60 stores a client distribution management program 64000, and by executing this program, the CPU 58 implements software distribution processing on the client 14 side.

The client distribution management program 64000 comprises a common client processing part 62 for implementing processing that is common to a plurality of clients, and a representative client-specific processing part 64 for implementing processing specific to the representative clients. Note that descriptions relating to each of the processing parts (62, 64) are also interchangeable with descriptions pertaining to the client distribution management program 64000.

The common client processing part 62 includes a client information transmission part 62A for transmitting client information to the server, a software reception processing part 62B for receiving a software image from the server 10 or from a representative client, and an installation processing part 62C for installing a software program by using the software image received from the representative client.

The representative client-specific processing part 64 comprises a software transmission processing part 64A for transmitting the software image received from the server 10 to the request-source client. The client disk 14B includes data 70 of software images received by the clients, a distribution task table 72 for tasks in which the software images are distributed to the request-source clients from the representative clients, and a transmission status table 74 showing statuses of transmitting the software images to the request-source clients from the representative clients.

Note that each of the processing parts stored in the memory 16 and the memory 60 may be program code and that, as mentioned earlier, some or all of the processing may be substituted with hardware. Furthermore, both the memory 16 and the disk 12 may be included in the storage resources of the server 10 as they are here; however, either the memory 16 or the disk 12 may instead be included as storage resources. In this case, the programs and information which are included in the memory 16 and the tables (information) included in the disk 12 may be thought of as being stored as the storage resources of the server 10.

Note also that when considering the storage resources of the client 14A, both the memory 60 and the disk 14B may be included as they are here; however, either the memory 60 or the disk 14B may instead be included in the storage resources. In this case, the programs and information which are included in the memory 60 and the tables (information) included in the disk 14B may be thought of as being stored as the storage resources of the client 14A.

FIG. 2 shows a flowchart for fulfilling the main functions of the server 10. The server 10 first collects client information of each of the plurality of clients 14 in the computer system (S200) and groups the clients 14 on the basis of the collected information (S202).

The server 10 then determines the priority ranking of the software images distributed to the clients 14 (S204) and calculates a redundancy-related characteristic value (redundancy coefficient value) when a software image exists in the client group (S206).

The server 10 calculates the priority rankings for the plurality of clients of each group (S208) and determines the representative client to which a software image should be distributed (S210). The server 10 then carries out the software image distribution and updates the distribution results (S212).

Each of the steps will be described in detail next.

The collection processing part 30A of the client information management processing part 30 accesses the plurality of clients 14 at regular intervals (or repeatedly), collects client information, mainly inventory information and performance information, from the client information transmission part 62A of each client, and updates and stores the collected information in the client information table 12C of the disk device 12.

An example of inventory information that is collected from the clients is address information (an IP address or subnet mask), as well as the disk capacity and unused capacity, of each client 14. This inventory information is used for the grouping of the clients 14. The collection processing part 30A calculates the average capacity utilization of the clients and registers these values in the client information processing table 12C.

FIGS. 3A and 3B show the client information processing table 12C. The client information management processing part 30 determines the average capacity utilization as follows, for example. Each client 14 is access by the server 10 at regular intervals and checks each time whether or not the client is operating.

The client information management processing part 30 determines the total operating time the clients 14 run for as the potential connection time, calculates the ratio of the potential connection time to the total value for the client working time, and takes this value as the average capacity utilization of each client. For example, if we assume that the total value of the operating times per day is 12 hours, from 08:00 to 20:00, that the server 10 transmits a connection check request to the client 14 twelve times every hour, and that there are nine responses from the client 14, the daily capacity utilization is 0.75 ( 9/12).

The client information management processing part 30 cumulatively records the capacity utilization for a prescribed number of days in an predetermined area of the memory 16 and takes the average of the cumulative values as the average capacity utilization. The daily capacity utilization of each client is stored in a client information history table (FIG. 4). The client information history table is also stored in the disk device 12. Client performance histories are stored in the client history table and updated on each date and the method for calculating values for the average CPU utilization, average disk I/O capacity, and average network I/O capacity is the same as the method for calculating the average capacity utilization.

(S202):

The grouping processing part 30B of the client information management processing part 30 refers to the client information table 12C and automatically categorizes the plurality of clients 14 into groups. The following may serve as systems for this purpose.
(a) A plurality of clients are divided into subnets.
(b) A plurality of clients are divided into multicast groups which are managed by the IGMP (Internet Group Management Protocol).
(c) The number of router hops is acquired and the plurality of clients are classified into groups using a threshold which is fixed or designated by the system administrator.
(d) The cost per path, using a routing protocol such as OSPF (Open Shortest Path First), is acquired, and the plurality of clients are classified into groups using a threshold which is fixed or designated by the system administrator.
(e) The plurality of clients are classified using differences between the branches to which the clients belong. To this end, the server 14 asks the system administrator to enter, for every client 14, identification information for each branch to which the client belongs, and registers the input result in the client information table 12C.

The grouping processing part 30B registers the result of grouping the plurality of clients 14 in the grouping table 12D of the disk device 12. FIG. 5 is an example of a grouping table and comprises group name entries and entries for the clients belonging to the groups.

(S204):

The priority ranking determination processing part 36A of the software information management processing part 36 of the management server 10 performs priority ranking determination processing to determine, for each group of clients 14, the ranking order for distributing the software image installed on the server 10 to the clients 14.

Note that in this embodiment, as mentioned earlier, in order to also cater to cases where a plurality of software images correspond to the same software program, an explanation will be provided by taking a case as an example in which information required to determine priority rankings is held for the software program. However, more simply, the same information may be held for software images. In this case, descriptions referring to each item of information as ‘software name’ or ‘software program name’ may be rewritten with ‘software image identifiers.’ Note that ‘software name’ has the same meaning as ‘software program name.’

The priority ranking determination processing part 36A performs priority ranking determination processing on software programs of a plurality of types for which there are entries in the software list table 12B shown in FIG. 6. The software list table 12B is stored in the disk device 12 and is referenced or updated by the software information management part 36. The following are systems for configuring priority rankings for software programs.
(f) The larger the capacity and transfer time required for the software image that a software program corresponds to, the higher the priority ranking configured for the software program.
(g) The higher the ratio (installation ratio) of the number of client machines where the software program is installed within the group to the total number of client machines, the higher the priority ranking configured for the software program.
(h) The higher a software program's most recent rate of increase in the installation ratio, the higher the priority ranking configured for the software program.
(i) The system administrator of the server 10 determines the priority ranking according to the order in which the plurality of software programs are configured. The priority rankings may alternatively be values that the system administrator configures for the software programs.

The software list table 12B contains the software program names and the sizes of the software images corresponding to the software programs. Note that if there are a plurality of software images corresponding to the same software program, the values entered for the applicable capacities may be values corresponding to the maximum value, average value, and minimum value, for example, of the images concerned.

The software list table may also contain installation rates and rates of increase in the installation rate. The determined priority ranking or the priority ranking and ranking order configured by the system administrator are configured in the software distribution ranking order and redundancy coefficient value table 12E. An example of this table is shown in FIG. 7.

The software distribution priority ranking and redundancy coefficient value table in FIG. 7 registers, in addition to the redundancy coefficient values calculated by the software information management processing part 36, the priority rankings of the software programs in each group, the number of downloads from the server of the software images corresponding to the software programs, and the total number of downloads. Note that the word ‘download’ indicates the ‘transmission’ of a download object from the standpoint of the download source and the ‘receiving’ of a download object from the standpoint of the download destination.

(S206):

The redundancy coefficient value calculation processing part of the software information management processing part 36 of the server 10 executes processing to calculate software redundancy coefficient values.

Here, ‘redundancy coefficient value’ is an index relating to redundancy after copies of specified software images have been incorporated into each of the groups; the redundancy coefficient value rises as the number of clients to which a software image has been distributed increases. Therefore when the client 14 requires a specified software image, the actual likelihood that the software image can be acquired from the representative client is high.

Note that where ‘copy of the specified software image’ is concerned, as long as the image in question corresponds to a specified software program which is the image source, the corresponding software image may be regarded as a copy even when the specified software image does not have the same data.

The server 10 configures the redundancy coefficient values for the software images corresponding to the software programs for each unit of time in response to an input from the system administrator in order to realize a predetermined likelihood that the request-source client will be able to access the software image cache of the representative client.

The redundancy coefficient value is determined through calculation and/or configuration by estimating, for each client group, a target value for the likelihood that a copy of a software image that is accessible to the client per unit time will be present in the applicable group The calculation or configuration of the redundancy coefficient values is performed sequentially using j to n below for a plurality of software programs for which there are entries in the software list table.
(j) The redundancy coefficient value calculation processing part 36B assigns the redundancy coefficient value of the software program corresponding to the largest capacity software image the value designated by the system administrator, and reduces the coefficient value in proportion to the reduction in the software image capacity.
(k) The redundancy coefficient value of the software program with the highest priority ranking configured by the system administrator is assigned the value configured by the system administrator and this value is reduced in proportion to the reduction in the priority ranking.
(l) The redundancy coefficient values of the software programs are assigned values configured by the system administrator.
(m) The redundancy coefficient value calculation processing part 36B assigns the initial value a specified value or a value determined in any of j to l. Thereafter, the redundancy coefficient value calculation processing part 36B refers to the software list table (with the capacities for each software) 12B and the software distribution priority ranking and redundancy coefficient value table (the number of downloads of the software program from the management server and the number of total software downloads) 12E, and measures at regular intervals ‘the capacity of the software in FIG. 6×(the number of downloads from the distribution management server the number of total downloads),’ that is, a combination of the capacity of the software image corresponding to a software program and the distribution status of the software image corresponding to the software program, and increases the redundancy coefficient value by a specified value if the average amount within a fixed period exceeds an upper limit threshold designated by the system administrator, and reduces the redundancy coefficient value by a specified value if this value is below a lower limit value.

Note that the total number of downloads is the total of the number of times a software image that corresponds to the software program is downloaded from the server 10 to the software request-destination client 14 and the number of times the software image is downloaded from the representative client in the same group.
(n) The measurement results of (m) above are sorted for a plurality of software programs and the redundancy coefficient value is increased by a specified value for the number of software programs designated in order by the system administrator starting with the largest value and reduces, by a specified value, the number of software programs designated by the system administrator in order starting with the smallest value program.

Here, the ‘number designated by the system administrator’ will be described in specific terms. For example, suppose that the server 10 distributes a plurality of software images that correspond to ten types of software programs are distributed to a representative client and that the redundancy coefficient of each software program is to be adjusted. To this end, the server 10 first sorts the software programs by their ranking order, increasing the redundancy coefficient for the three highest types and conversely reducing the redundancy coefficient for the lower three types. ‘3’ in the example below is a ‘number designated by the system administrator.’

(S208, S210):

A representative client management processing part 32 of the server 10 determines, for each group, the representative clients for distribution in advance using a system for caching software images in order to fulfill the pull-type software image distribution requests from the client.

The representative client is a client configured to serve as a representative in each group by receiving the distribution of a software image from the server 10 and re-transmitting the software image to the clients the representative client governs, and the representative client management processing part 32 comprises a client priority ranking determination processing part 32A and a software image distribution destination determination processing part 32B.

The server 10 priority-ranks the software programs (S204), and after completing the calculations of the redundancy coefficient values of the software programs (S206), performs client ranking order processing (S208) and processing to determine the representative clients to which the software should be distributed (S210).

The ranking order determination processing part 32A of the server 10 performs priority ranking of the clients for each group in order to determine or select clients as candidates for the representative clients to which the software image corresponding to the software program is to be distributed. The priority ranking determination processing part 32B refers to one or a set of the plurality of aspects below in order to determine the ranking order, that is, priority ranking of the clients.
(o) The client should not be a notebook PC. Clients likely to be disconnected from the network are assigned a lower priority ranking.
(p) The lower the average CPU utilization, the higher the ranking order.
(q) The lower the average disk I/O, the higher the ranking order.
(r) The lower the average network I/O, the higher the ranking order.
(s) The higher the average capacity utilization, the higher the ranking order.
(t) The smaller the number of software images or the number of software programs that have been distributed or scheduled for distribution, the higher the ranking order.
(u) The smaller the total volume of software images or the total volume of software programs that have been distributed and/or scheduled for distribution, the higher the ranking order.

The priority ranking determination processing part 32A determines the ranking order based on (o) to (s) by referring to the client information table 12C. The priority ranking determination processing part 32A determines the ranking order according to (t) and (u) by referring to the software distribution status table 12F.

The priority ranking determination processing part 32A associates, with the software name serving as a key, the software list table 12B with the software distribution status table 12F in order to obtain the capacity of the software image (or software program) distributed to the representative clients.

When the priority ranking determination processing part 32A subsequently determines the clients' priority ranking, the distribution destination determination processing part 32B determines the representative client (group) to which the software image corresponding to the software program should be distributed (S210).

That is, the distribution destination determination processing part 32B determines, for each group, the clients that belong to the group by referring to the grouping table 12D.

The distribution destination determination processing part 32B then sorts the clients in order of priority as determined in S2010 and integrates the average capacity utilization by sequentially obtaining the average capacity utilization for each client on the basis of the client information table 12C.

The distribution destination determination processing part 32B refers to the integration value, and the redundancy coefficient value for the software program registered in the software distribution priority ranking and redundancy coefficient table, continues to sort the clients until the integration value exceeds the redundancy coefficient value, and finishes sorting clients when the coefficient value is exceeded.

The clients that have passed through the sorting process then serve as representative clients for the software programs for which a redundancy coefficient value comparable to the integration value has been configured. One or more of clients are classified as representative clients.

Note that if the capacity of the software exceeds the maximum disk capacity of the selected client, the client is not selected as a representative client and the distribution destination determination processing part 32B then sorts the next client based on the priority ranking.

Upon determining the representative client to which the software image corresponding to the software program is to be distributed, the distribution destination determination processing part 32B adds an entry for the representative client to the software distribution status table 12F.

FIG. 8 is an example of a software distribution status table. The software distribution status table includes entries for the group names, entries for the names of the software to be distributed, entries for the representative clients in each group, and entries for the distribution status of the corresponding software image in each software program.

Upon determining the representative client, the distribution destination determination processing part 32B adds an entry for the representative client to the software distribution status table and registers ‘distribution scheduled’ as the software program distribution status (800). Note that when the software image corresponding to the software program is distributed, the status is changed to ‘distributed’ (802).

Note that arrangements that allow the server 10 to determine the clients to which the software image corresponding to the software program is to be distributed, irrespective of the redundancy coefficient value of the software, include a system for maximizing the redundancy coefficient value of the software program, that is, a system with which a software image corresponding to the software program is distributed to all the clients in the group, a system for minimizing the disk usage rate, or an arrangement whereby the software image corresponding to the software program is distributed only to the client with the greatest priority ranking in the group, for example.

(S212):

The communication processing part 40 of the server 10 then, as per S214 in the flowchart, executes processing to distribute the software image to the representative clients, as determined in S212, which are the distribution destinations of the software image corresponding to the software program, and executes distribution result reception processing, in which the distribution results are received from the representative clients and registered in the software distribution status table 12F.

The distribution processing part 40A transfers the software image stored on the disk to the representative client group. The distribution of software images is performed in order starting with the highest software program priority ranking. The system administrator is able to configure restrictions, for predetermined software programs, on the groups to which the software images corresponding to the software programs are to be distributed.

If there are a plurality of representative clients in a group, the distribution processing part 40A attempts unicast communication with the representative clients in order starting with the highest priority ranking. The distribution processing part 40A transmits the software image and list information for discriminating other representative clients to the representative clients for which communication has succeeded.

The representative clients which have received the distribution of the software image perform unicast communication with the other representative clients in the same group and transfer the software image.

Furthermore, when, using distribution result reception processing, the result reception processing part 40B confirms distribution result responses to the effect that the software image has been received from the representative clients to which the software image was distributed, the result reception processing part 40B changes the status fields in the software distribution status table 12F from ‘distribution scheduled’ to ‘distributed’ (802).

The distribution of a software image to the representative clients from the management server involves first processing in which the server 10 transmits the software image to the representative clients 14, second processing in which the representative client 14 receives the software image from the management server 10, and third processing in which the representative client transmits the software image to other representative clients in the same group.

FIG. 9 is a flowchart corresponding to the first processing; FIG. 10 is a flowchart corresponding to the second processing; and FIG. 11 is a flowchart corresponding to the third processing.

The flowchart of FIG. 9 will now be explained. The distribution processing part 40A refers to the software distribution status table 12F and specifies the representative clients to which the software image is to be distributed.

The distribution processing part 40A then transmits a request to check the acquisition status of the software image to be distributed to the representative client with the highest priority ranking and receives a request response result (S900).

Note that if there is no response to the request, communication with the request destination representative client is not possible, and the distribution processing part 40A then transmits a request to another representative client according to priority ranking. Furthermore, the distribution processing part 40A selects the software image corresponding to the software program that is to be distributed, on the basis of the software distribution status table 12F.

Thereafter, the result reception processing part 40B determines whether or not the representative client has acquired the software image corresponding to the software program on the basis of the response result from the representative client that received the request (S902), and transmits a software image to the representative client when this determination is negative (S904). When S902 yields an affirmative result, the result reception processing part 40B jumps to S904.

The result reception processing part 40B then updates the status of the representative client that acquired the software image to ‘distributed’ in the software distribution status table 12F (S906).

The result reception processing part 40B then refers to the software distribution status table 12F and searches for another representative client belonging to the same group as the representative client to which the software image was distributed (S908).

This search is conducted as follows. The result reception processing part 40B selects a table entry from the software distribution status table 12F that satisfies all the following criteria.
The group name is the same as the group name corresponding to the representative client which received the software image transmission.
The software name is the same as the software name of the software program corresponding to the software image distributed to the representative client.
The status is ‘distribution scheduled.’
The distribution processing part 40A transmits the client name(s) pertaining to one or more selected entries to the representative client to which the software image was sent in S904 (S910).

The processing for receiving a software image from the server 104, which is performed by the representative clients 14, will be explained next with reference to FIG. 10. When the software reception processing part 62B of the client 14 receives a request to check the acquisition status of the software image from the server 10 (S1000), the software reception processing part 62B refers to the software image data in the disk device 14B to determine whether or not the software image has been acquired (S1002).

When a negative determination is made, the software reception processing part 62B issues a response to the result reception processing part 40B of the server 10 that the software image has not been acquired (S1004).

Thereafter, the software reception processing part 62B receives the software image from the server 10 via the communication interface 50 and saves the software image via the disk interface 52 in the software image storage area of the disk 14B (S1006).

The software reception processing part 62B then receives the list of client names from the server 10 and registers the received data in the software distribution task table 72.

The software distribution task table 72 manages tasks in which a representative client that has received a software image transmission transmits the software image to other representative clients in the same group.

FIG. 12 shows an example of a software distribution task table. The software distribution task table includes task entries, entries for the names of source software programs of the software images to be sent, entries for representative clients to which the software images corresponding to the software programs are to be sent, and transmission status entries.

Note that an identifier for the software image may also be used instead of the software program name. The software transmission processing part 64A configures the transmission status as ‘incomplete’ in an initial state where the client name is registered in the transmission task list table. Note that when S1002 is negative, the processing jumps to S1006.

A flowchart in which a representative client 14 which has received distribution of a software image from the server 10 distributes the software image to other representative clients belonging to the same group as the representative client will be explained next with reference to FIG. 11.

In order to make the explanation of this flowchart easier to understand, the two representative clients will be suitably distinguished by naming the former representative client the ‘first representative client’ and the latter the ‘second representative clients.’

The software transmission processing part 64A of the first representative client refers to the software distribution task table 72 and selects the second representative clients with the status ‘complete’, and determines whether or not it is possible to connect to the selected second representative clients via the communication interface 50 and LAN 76 (S1100).

When this determination is affirmative, the software transmission processing part 64A transmits a request to the second representative clients to check the software image acquisition status, and receives the resulting response (S1102).

The software transmission processing part 64A then determines, based on the response, whether or not the second representative clients have acquired the software image (S1104).

When this determination is negative, the software transmission processing part 64A reads the software image from the disk device 14B and transmits the software image to the second representative client (S1106).

The software transmission processing part 64A then reads the list of representative client names from the software distribution task table 72 and transmits this list to the second representative clients (S1108).

The software transmission processing part 64A of the first representative client updates the ‘status’ of the second representative clients which are the software image destinations in the software distribution status table 72 to ‘sent’ (S1110), and upon receiving a response to the effect that the software image has been received from the second representative clients, reports the fact that the software image has been sent from the first representative client to the second representative clients (S1112).

Note that a distribution status screen display processing part 42 of the server 10 creates a software image transmission status table on the basis of the related reports from the second representative clients and displays this table to the system administrator. This table will be described in detail subsequently.

The software transmission processing part 64A then updates the ‘status’ entries of the second representative clients associated with the name of the targeted software in the software distribution task table 72 to ‘complete’ (S1114).

Note that, upon making a negative determination in S1104, the software transmission processing part 64A updates the ‘status’ of the software distribution task table to ‘no connection’ and terminates the processing. Furthermore, upon making an affirmative determination in S1104, the software transmission processing part 64A jumps to S1110.

The operation in which the software transmission processing part 64A acquires the software image from the representative client and installs the software image will be explained next.

If a client user requires a certain software program, the client acquires a list of representative clients belonging to the same group as its own from the server and sequentially accesses the representative clients in this list.

If the client is able to communicate with one of the representative clients and the representative client is holding the software image corresponding to the desired software program, the client receives the software image from the representative client. If the client is unable to communicate with any of the representative clients or none of the representative clients is holding the software image corresponding to the desired software program, the client acquires the software image corresponding to the desired software program from the management server.

If a distinction is required between downloads from the server and downloads from the representative clients when determining the software priority ranking and redundancy coefficient value, the client reports the type of the software image source (either the management server or the representative client) to the server. The client then installs the desired software program by using the software image received.

If the server manages licences to use the software program or uses the number of software program installations as a parameter for managing software program distribution, the client reports to the server that the software program has been installed.

Note that the representative clients do not install a software program in the same way as the request-source client but rather hold a software image corresponding to the software program in memory in a cached (temporary copy) state. Meanwhile, if a representative client requires the software program, an installation may be performed using the software image cache.

FIG. 13 is a flowchart of software distribution processing of a representative client. Upon receiving a connection request from the client (S1300), the software transmission processing part 64A of the representative client determines whether or not a software image corresponding to the software program requested by the client is held (S1302), and upon making an affirmative determination, the software transmission processing part 64A transmits information indicating that a software image corresponding to the requested software program is being held to the request-source client (S1304), and then transmits the software image corresponding to the requested software program (S1306).

When the determination in S12002 is negative, the representative client transmits information indicating that a software image corresponding to the requested software program is not held to the request-source client (S1308).

FIG. 14 is a flowchart of software image reception processing and installation processing of the software request-source client. The software reception processing part 62B of the client 14 receives an input with the name of the software program to be installed from the user (S1400).

The software reception part 62B then acquires list information from the server 10 regarding the representative clients holding the software image corresponding to the software program designated by the user in S1400 in the group to which the software reception part 62B belongs (S1404). The software reception part 62B which has acquired the list information performs processing (described subsequently) on the representative clients in the list.

The software reception processing part 62B of the request-source client 14 then transmits a software image acquisition request to the representative client (S1406). Note that the name of the software program is designated in the request but the identifier of the software image may be indicated instead.

The request-source client 14 determines whether or not the representative client is holding a software image corresponding to the intended software program on the basis of the response from the representative client (S1407).

When the determination is affirmative, the software reception processing part 62B receives the software image corresponding to the intended software program from the software transmission processing part 64A of the representative client (S1408).

The request-source client 14 reports to the server that the software image corresponding to the software program has been downloaded from the representative client (S1410) and then executes S1416 (described subsequently) (S1410).

When the determination of S1407 is negative, the request-source client 14 accesses another representative client (transmits an acquisition request), and attempts to acquire the software image corresponding to the software program. When the software image acquisition is successful (S1412: No), the request-source client 14 installs the software program using the software image acquired (S1416) and transmits notification to that affect to the server (S1418).

When, on the other hand, the software reception processing part 62B of the request-source client determines that a software image corresponding to the software program cannot be acquired from any of the representative clients (S1412: Yes), the software reception processing part 62B accesses the server 10 and receives a software image distribution from the distribution processing part 40B of the server 10 (S1414).

The installation processing part 62C of the client 14 which has received the software image distribution installs the software program using the distributed software image (S1416) and transmits notification to that affect to the server (S1418).

Operation of the representative client in a case where there are simultaneous requests to the representative client to distribute a software image from a plurality of clients will be explained next.

If a certain representative client in a certain group simultaneously processes a prescribed number or greater of acquisition requests for the same software image at a certain point in time, the representative client or server configures one of the clients issuing the request as a new representative client, and parallelizes the transmission processing. Processing pertaining to the representative client will now be explained using a flowchart.

FIG. 15 is a flowchart providing an overview of representative client operation. Upon receiving a connection request from the software image request-source client (S1500), the representative client determines whether or not a software image corresponding to the requested software program is held (S1502).

When the determination is negative, the software transmission processing part 64A of the representative client transmits information indicating that a software image corresponding to the software program is held to the request-source client (S1504).

The software transmission processing part 64A of the representative client then transmits the software image corresponding to the software program to the request-source client and creates a new representative client (S1506). Details of these steps are as shown in the flowchart in FIG. 16 which will be described subsequently.

Upon determining that a software image corresponding to the requested software program is not held, the representative client transmits information to that effect to the request-source client (S1508).

As shown in the flowchart of FIG. 16, the software transmission processing part 64A of the representative client stores target clients to which the software image is to be transmitted in a predetermined work area of the memory 60 (S1600). If a plurality of target clients exist, the plurality of target clients are stored in the work area.

The software transmission processing part 64A refers to the work area, and when a plurality of clients are registered therein, configures a target number for executing a software parallel transmission, that is, a parallel processing number (S1602).

The software transmission processing part 64A compares the parallel processing number with the prescribed number (S1604), and when it is determined that the parallel number is equal to or greater than the prescribed number, registers the information required in the software transmission status table 74 of the disk device 14B.

FIG. 17 is an example of a software transmission status table. The software transmission status table contains entries for software program names, entries for the names of software destination clients, entries for new representative flags, relay flag entries, and entries for the names of source clients from which software images corresponding to the software programs are received.

The software transmission processing part 64A of the representative client selects a new representative client from certain clients, and puts up a new representative flag in the entries for those clients with the destination client names, in the software transmission status table 74 (S1605).

Note that if a representative flag has already been elected in at least one of the clients among the plurality of destination clients, this processing is not actually executed.

Methods for selecting a new representative client include a system for deriving the new representative client from a client to which a software image corresponding to a software program with the smallest number of bytes is scheduled to be sent.

The representative client which requested the software image distribution issues an inquiry to a central server, and makes the new representative client the client with the highest priority ranking in the group of clients to which the software image is to be distributed.

Upon determining that the parallel processing number is smaller than the prescribed number or terminating the processing of S1605, the software transmission processing part 64A adds a transmission target client name to the software transmission status table 74 (S1606). The software transmission processing part 64A then performs processing to transmit the software image. This processing will now be explained in detail with reference to FIG. 18. Note that transmission processing is realized by dividing a software image into a plurality of blocks which are sequentially transferred.

The software transmission processing part 64A of the representative client configures the packet type for sending the blocks as ‘software’ (S1800). The software transmission processing part 64A then sends packets to clients which are the transmission targets (S1802).

The software transmission processing part 64A then searches the software transmission status table, checks for relay flags for the transmission target clients (S1804), and determines whether relay flags exist (S1806).

Upon determining that no relay flags have been elected, the software transmission processing part 64A determines that software transmission is complete (S1808), and returns to S1800 when the software transmission is determined as incomplete. When the software transmission is determined as complete, the software transmission processing part 64A moves to S1610 in FIG. 16.

When it is determined in S1806 that a relay flag has been elected, the software transmission processing part 64A of the representative client configures the packet type as ‘relay’ (S1810), transmits the packets to the destination client, transmits source client information of the software transmission status table 74 to the client that sent the packet (S1812), and moves to S1610 in FIG. 16.

In S1610 in FIG. 16, upon determining that the software image transmission is relayed, the software transmission processing part 64A of the representative client deletes the entries for the names of clients to which the software image is relayed from the software transmission status table (S1612).

Upon determining in S1610 that the software image has not been relayed, the software transmission processing part 64A of the representative client configures the packet type as ‘complete’ (S1613).

The software transmission processing part 64A of the representative client then refers to the software transmission status table 74 to determine whether or not a new representative flag has been elected for the transmission target clients (S1614). Upon determining that a new representative flag has not been elected, the software transmission processing part 64A notifies the transmission target clients that they are not new representative clients (S1616). Upon determining that a new representative flag has been elected, the software transmission processing part 64A notifies the transmission target clients that they are new representative clients (S1618). The software transmission processing part 64A also notifies the server that transmission target clients are now new representative clients (S1620).

Thereafter, the software transmission processing part 64A selects half of or a designated proportion of the clients undergoing transmission processing, and elects a relay flag in the applicable client entries in the software transmission status table 74 (S1622).

The software transmission processing part 64A records the names of the new representative clients for which a new representative flag has been elected as the source clients for the destination client entries for which a relay flag has been elected (S1624).

The operation of the clients receiving the software image distribution from the server or the new representative client is as per earlier FIG. 14 but the process for ‘receiving a software image’ (S1408) may be replaced with the routine in FIG. 19.

That is, upon acquiring a packet, the software reception processing part 62B of the request-source client checks the packet type (S1900).

The software reception processing part 62B then determines the packet type (S1902). If the packet type is configured as ‘complete,’ the software reception processing part 62B checks the packet data (S1904), determines whether or not there is a command to elect new representative flag data (S1906); when the determination is affirmative, the software reception processing part 62B saves all the blocks of the software image, which are received from the representative client, in a distribution software data storage area of the disk 14B (S1908).

If, on the other hand, the packet type is configured as ‘software,’ the software reception processing part 62B saves the received blocks in the disk 14B (S1912). Furthermore, if the packet type is configured as ‘relay,’ the client which receives the relay packets and to which the software image distribution is relayed, accesses the source client of the software transmission status table 74 as the new representative and receives the relayed software image retransmission from the source client (S1910).

An operation in which a copy of a software image corresponding to the software program temporarily installed in the client group is re-installed by the server will be explained next. Note that the definition provided earlier for a software image copy applies here.

The server calculates the priority rankings and required redundancy coefficient values of software programs at regular intervals or when checking for additional client installations/client removals, for example, and if the latest calculation result reveals that the installation of the software image copy has gone array, re-installs the software image copy in the client group.

The re-allocation processing that is performed by the server will be described hereinbelow. The server re-allocation processing part 34 executes the following processing at regular intervals.
(1) Checks for additional client installations/client removals. The server collects inventory information from the clients connected to the server and checks for additional client installations/client removals within the same group. The server calculates additional client installations/client removals on the basis of the difference between the previous collection result and the latest collection result. The server records the date of the latest update each time inventory information is collected, and determines that a client has been removed when the client has not been updated for a time interval designated by the system administrator.
(2) If a client is newly installed/removed, the server maintains the list of representative clients. When client installations/client removals extend to representative clients, the server deletes entries for removed client(s) in the software distribution status table 12F and so on.
(3) Software program priority rankings, redundancy coefficients, and client priority rankings are recalculated for client groups that have been subject to client installations/client removals.
(4) Software images corresponding to the software programs are re-installed for the client groups. Re-allocation processing methods take many forms.

There exist, for example, (A) a system for matching the installation statuses of a software image corresponding to a software program within a client group to the priority rankings of the software and/or clients, and (B) a system for re-installing the corresponding software image if the current distribution status of the software image corresponding to the software program does not satisfy the redundancy the system administrator desires or exceeds the redundancy desired by the system administrator.

System (A) will be explained first. The re-allocation processing part 34 of the management server obtains one or more candidates for a new representative client for a client group that has undergone a new client installation/client removal. The re-allocation processing part 34 compares existing representative clients with new representative clients, and determines clients that have been removed from the representative clients and clients that have become new representative clients.

The re-allocation processing part 34 sends the address of a client that has become a new representative client to any one of the existing representative clients and transmits a command to send software from the existing representative client to the new representative client.

The software transmission processing part 64 of the representative client which has received the software transmission command transmits a software image to each of the new representative clients, and when transmission is complete, reports the fact that transmission is complete to the re-allocation processing part 34 of the server. Upon receiving the transmission completion report, the server sends a command to delete a software image to clients that have been excluded from the representative clients.

System (B) will be explained next. The re-allocation processing part 34 refers to the client information table 12C regarding the current representative clients, and acquires and calculates the latest average capacity utilization [in each case].

The calculation result is compared with the corrected redundancy coefficient value, and if the redundancy coefficient value is inadequate, new clients are assigned a new representative role according to their priority ranking to compensate for the shortfall.

Furthermore, the re-allocation processing part 34 selects one of the existing representative clients, selecting the client with the smallest I/O load, for example, and sends a command to this client to transmit a software image to the new representative client.

Conversely, if the redundancy coefficient value is exceeded, the re-allocation processing part 34 sequentially removes the representative clients with the lowest priority rankings among existing representative clients from the targets for integrating the average capacity utilization, and continues this process until the integration result is lower than the corrected redundancy coefficient value. The re-allocation processing part 34 determines that those clients that were removed up until directly before the integration result fell below the redundancy coefficient value should be removed from the representative clients and issues a command to these clients to delete the software images.

Upon receiving a screen display request from the system administrator, the server distribution status screen display processing part 42 generates management display information on the basis of the information in each of the updated tables on the disk 12, and outputs this information by displaying the information on the management screen of the screen display client 28. FIG. 20 is an example of the management screen. This management screen includes the following entries.

The group name corresponds to the group name column in the software distribution status table 12F. The {total disk capacity, total unused disk capacity} of each group correspond to the total disk capacity column and the unused disk capacity column in the client information table 12C.

The total capacity of the distributed software images in each group is a value obtained by associating the software distribution status table 12F and the software list table 12B with the software program names and then adding together, for each group, the ‘size’ of the entries for which the status column in the software distribution status table 12F is ‘distributed.’

The software name corresponds to the software name column in the software distribution status table 12F. The ‘number of representative clients, representative client names’ of each group and each piece of software correspond to the client name column in the software distribution status table 12F. The software-program redundancy coefficient values of each software program in each group correspond to the values in the redundancy coefficient value columns in the software distribution priority ranking and redundancy coefficient value table 12E.

The history of the total average capacity utilization of all the representative clients for each software program in each group corresponds to a value that is obtained by linking the software distribution status table 12F and the client information table 12C with respect to the client names and adding together the daily average capacity utilizations of every group or software program for the entries for which the status column of the software distribution status table 12F is ‘distributed.’

The following serves as a modification of the aforementioned embodiment. In response to a direction from the server, the client determines whether it is a representative client, and if indeed a representative client, the client transmits information (address, capacity and so forth) on an area where the software is cached. The server distributes software to the client in accordance with the information from the client.

Although a push-type distribution example in which distribution is from the server to the representative client was described in the aforementioned embodiment, a system for distributing software programs to representative clients does not rule out pull-type distribution based on requests from representative clients.

Moreover, in the above embodiment, in a case where a pull-type client (or representative client) requests software image acquisition from a representative client or server, the pull-type client designates a software program name in the request (the same may also apply between representative clients or between a representative client and the server).

As a result, the pull-type client receives a software image that corresponds to the designated software program name from the representative client or server. Furthermore, since a plurality of software images may exist for the installation of one software program, the focus of this disclosure of software image distribution management is on performing distribution management for software programs (carrying out the storage of required information and/or processing).

However, an identifier for the software image may also be used instead of the software program name designated at the time of acquisition. Moreover, rather than software programs being used for the distribution management of software images, distribution management may be performed using software images.

### INDUSTRIAL APPLICABILITY

In the computer system according to the present invention, the management server comprises software images and can be integrated into a system for distributing the software images to clients on the basis of a client request requiring software images.

### REFERENCE SIGNS LIST

10 Software distribution management server

12 Server disk device

14 Client

14A Representative client

14B Client disk device

28 Screen display client

1. A method of managing distribution of a software image corresponding to a software program in a computer system,
the computer system comprising:
a plurality of client computers;
a server computer including software images for distribution to one or more of the plurality of client computers; and
a network for coupling the server computer to the plurality of client computers,
in which method the server computer executes:
a first step of classifying the plurality of client computers into a plurality of groups on the basis of information from the plurality of client computers;
a step of selecting a representative client computer for each group; and
a step of distributing the software image corresponding, to the software program to the representative client computers, and
in which method
the representative client computers which have received the software image distribution distribute the software image to other client computers belonging to the same group on the basis of a request from the other client computers.

2. A method of managing distribution of a software image in a computer system according to claim 1,
wherein the server computer
comprises a plurality of the software images,
determines respective priority rankings on the basis of attributes of the plurality of software programs or software images, and
distributes the plurality of software images to the representative client computers in accordance with a ranking order based on the priority rankings.

3. A method of managing distribution of a software image in a computer system according to claim 2,
wherein the server computer
determines each of the priority rankings on the basis of resource information of the plurality of client computers, and
distributes the software image to the representative client computers in accordance with the ranking order based on the priority rankings.

4. A method of managing distribution of a software image in a computer system according to claim 3,
wherein the server computer
configures, for at least one of the plurality of groups, a ratio-related target value for the existence of the software images,
determines the operating status of each of the plurality of client computers on the basis of resource information that is collected from the plurality of client computers,
sequentially selects one client computer according to the priority rankings of the client computers from among the plurality of client computers belonging to the group for which the target value has been configured,
continues to select the client computers until the total value of the operating status information of the selected client computers reaches the target value, and
configures one or more of the selected client computers as the representative client computer.

5. A method of managing distribution of a software image in a computer system according to claim 4,
wherein the higher the priority ranking of the software program, the higher the target value which the server computer configures.

6. A method of managing distribution of a software image in a computer system according to claim 3,
wherein the server computer
configures a plurality of the representative client computers in the same group, and
distributes the software image to one representative client computer by accessing one of the plurality of representative client computers in order of priority ranking, and
the representative client computer which has received the software image distribution distributes the software image to other representative client computers.

7. A method of managing distribution of a software image in a computer system according to claim 3,
wherein, when the representative client computer receives requests from the plurality of client computers to distribute the same software image,
the server computer
configures at least one of the plurality of client computers as a new representative client computer, and
distributes the software image from the new representative client computer to client computers other than the new representative client computer among the plurality of client computers.

8. A method of managing distribution of a software image in a computer system according to claim 7,
wherein the server computer configures the client computer with the highest priority ranking among the plurality of client computers as the new representative client computer.

9. A method of managing distribution of a software image in a computer system according to claim 7,
wherein the representative client computer relays the software image distribution to the plurality of client computers other than the new representative client, and
the new representative client computer executes the distribution of the software image to the client computer with which the software image distribution is relayed.

10. A method of managing distribution of a software image in a computer system according to claim 1,
wherein the server computer
configures changes to the representative client computers after distributing the software image to the representative client computers, and
re-arranges the software image distribution to the changed representative client computers.

11. A method of managing distribution of a software image in a computer system according to claim 10,
wherein the server computer
determines new client computer installations and/or removals, and
configures the changes on the basis of this determination, and
wherein new representative client computers, based on the configured changes, receive the software image distribution from the representative client computers prior to the configured changes, and
wherein the client computers removed from the representative client computers delete the distributed software images on the basis of the configured changes.

12. A computer system, comprising:
a plurality of client computers;
a server computer that includes a software image to be distributed to one or more of the plurality of client computers; and
a network for coupling the server computer to the plurality of client computers,
wherein the server computer comprises:
an interface with the plurality of client computers,
a first memory which contains a distribution management program for the software image,
a second memory which contains distribution management information for the software and the software image, and
a CPU for executing distribution management processing for the software image on the basis of the distribution management program and the distribution management information,
wherein the CPU
classifies the plurality of client computers into a plurality of groups on the basis of information from the plurality of client computers,
selects a representative client computer for each group, and
distributes the software image to the representative client computers,
wherein the representative client computers which have received the software image distribution distribute the software image to the other client computers, and
wherein the CPU generates management display information on the basis of the distribution management information for the software image of the second memory, and outputs the management display information to a management screen.

13. A computer system for software image distribution management according to claim 12, wherein the second memory contains a plurality of the software image,
wherein the CPU
determines respective priority rankings on the basis of attributes of the plurality of software images and respective priority rankings on the basis of resource information of the plurality of client computers,
distributes the plurality of software images to the representative client computers in accordance with a ranking order that is based on the determined priority rankings,
configures a ratio-related target value for the existence of the software images in at least one of the plurality of groups,
determines the operating status of each of the plurality of client computers on the basis of the resource information collected from the plurality of the client computers,
sequentially selects one client computer in accordance with the priority rankings of the client computers from among a plurality of client computers that belong to the group for which the target value was configured,
continues to select the client computers until the total value of the operating status information of the selected client computers reaches the target value,
configures one or more of the selected client computers as the representative client computers,
configures a plurality of the representative client computers in the same group,
distributes the software images to one representative client computer by accessing one of the plurality of representative client computers in order of the priority rankings,
causes the representative client computer which has received the software image distribution to distribute the software images to the other representative client computers,
upon receiving requests from the plurality of client computers to distribute the same software image, the representative client computer
configures at least one of the plurality of client computers as a new representative client computer, and
causes the new representative client computers to distribute the software images to client computers other than the new representative client computers among the plurality of client computers,
wherein the representative client computer relays the software image distribution to the plurality of client computers other than the new representative client computers,
wherein the new representative client computers execute distribution of the software images to the client computers via which the software distribution is relayed, and
wherein, upon determining new installations and/or removals of the client computers,
the CPU
configures changes to the representative client computers after distributing the software images to the representative client computers,
causes the new representative client computers based on the configured changes to receive the software image distribution from the representative client computers prior to the configured changes, and
based on the configured changes, causes the client computers removed from the representative client computers to delete the distributed software image.

14. A storage medium that can be read by a server computer, a first client computer, and a second client computer which is coupled to the server computer and the first client computer,
wherein the storage medium stores
representative client specifying program code which causes the second client computer to receive information specifying representative clients from the server computer and to specify a representative client computer from the first client computer and the second client computer on the basis of the information specifying the representative clients;
software distribution program code which, if the representative client computer is the second client computer, causes the second client computer to execute (A1) to (A3) below;
software allocation program code which causes the second client computer to:
(A1) receive a software image of a software program from the server computer and store the software image in memory or on a disk of the second client computer,
(A2) receive the software acquisition request, and check whether a software image corresponding to the software program designated by the software acquisition request is stored in the memory or disk of the second client computer, and
(A3) if, as a result of the check in (A2), a software image of the designated software program is stored, transmit a software image corresponding to the designated software program, and which software installation program code, if the representative client computer is the first client computer, causes the second client computer to execute (B1) to (B4) below; and
representative client display program code which causes the second client computer to
(B1) receive an installation input designating a predetermined software program to be installed,
(B2) transmit a software acquisition request designating the predetermined software program to the representative client computers or the server computer,
(B3) receive a predetermined software image corresponding to the predetermined software program in accordance with the software acquisition request, and
(B4) install the predetermined software program using the predetermined software image, and which representative client display program code causes the second client computer to display identifiers of the representative client computers.
